(19) United States
(12) Patent Application Publication
(10) Pub. No.: US 2026/0278082 A1
(43) Pub. Date: Sep. 17, 2026

(54) LOW POWER INTRUDER EVENT

(71) Applicant: Lenovo (United States) Inc., Morrisville, NC (US)

(72) Inventors: Omar Ali, Cary, NC (US); Arvind Varadarajan, Apex, NC (US)

(21) Appl. No.: 19/081,629

(22) Filed: Mar. 17, 2025

(51) Int. Cl. G06F 21/55

(52) U.S. Cl. CPC G06F 21/554; G06F 2221/034

(57) ABSTRACT

One embodiment provides a method, the method including: detecting, at a microcontroller unit of a device in a mechanical-off state, an intruder event; logging, at the microcontroller unit of the device, the intruder event, wherein the logging comprises storing at least a timestamp associated with the intruder event; and providing, upon powering the device, data corresponding to the intruder event from the microcontroller unit to an embedded controller of the device. Other aspects are claimed and described.

### BACKGROUND

Adjustment to hardware components of a device can heavily influence the operating of the device. A change in hardware components, whether an addition of a component, a removal of a component, an adjustment to a component, and/or the like, may cause the device to operate in a new manner. It is common practice to log changes of hardware components where logged changes may then be used to identify why a device may be operating differently than originally designed. For example, the addition of a larger battery may result in a longer active lifespan of a device. Alternatively, for example, the addition of a new battery may negatively influence additional hardware components because such an increase in power cannot be supported. No matter the adjustment made to a device, recording a component change in order to explain a future result assists with understanding why a device is operating a certain way.

### BRIEF SUMMARY

In summary, one aspect provides a method, the method including: detecting, at a microcontroller unit of a device in a mechanical-off state, an intruder event; logging, at the microcontroller unit of the device, the intruder event, wherein the logging comprises storing at least a timestamp associated with the intruder event; and providing, upon powering the device, data corresponding to the intruder event from the microcontroller unit to an embedded controller of the information handling device.

Another aspect provides a system, the system including: a processor; a memory device that stores instructions that, when executed by the processor, causes the system to: detect, at a device in a mechanical-off state, an intruder event; log, at a microcontroller unit of the device, the intruder event, wherein to log comprises storing at least a timestamp associated with the intruder event; and provide, upon powering the device, data corresponding to the intruder event from the microcontroller unit to an embedded controller of the information handling device.

A further aspect provides a product, the product including: a computer-readable storage device that stores executable code that, when executed by a processor, causes the product to: detect, at a device in a mechanical-off state, an intruder event; log, at a microcontroller unit of the device, the intruder event, wherein to log comprises storing at least a timestamp associated with the intruder event; and provide, upon powering the device, data corresponding to the intruder event from the microcontroller unit to an embedded controller of the information handling device.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for utilizing a microcontroller unit added to a device in order to detect intruder events of a device while the device is in a mechanical-off state.

FIG. 4 illustrates an example of a simple information handling device circuitry containing an added microcontroller unit for detecting intruder events.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Hardware components of a device have a standard lifespan associated with them. For example, a typical coin battery present on a board of a device should sustain its power for around 5 years. However, certain components of the device may influence this lifespan. The coin battery is often used in devices to keep certain components awake or active, even where the rest of the device has been powered off or is in a mechanical off state and there is no external power. For example, many devices include an embedded controller that is powered by a coin battery. The embedded controller may perform different functions, with one function being the detection of intruder events. Intruder events are typically events where the housing of the device has been breached, for example, by a user installing a hardware component, removing a hardware component, adjusting a hardware component, and/or the like. These events are useful to detect in order to identify when the housing of the device has been breached in order to determine if such a breach has caused a change in the functioning of the device. Thus, when such an event is detected, this event is logged along with information corresponding to the event. Utilizing the coin battery to power the embedded controller has resulted in the coin battery being drained much quicker than the expected 5-year lifespan.

One technique for accounting for this drain on the embedded controller is to include a larger coin battery and/or an additional battery. However, when inputting a larger coin battery and/or and additional battery onto a motherboard of a device, design issues arise, for example, real estate on a motherboard. The inclusion of a larger and/or additional battery will take up more space on a motherboard, and therefore, a device will have to increase in size. Increasing the size of a motherboard can drastically influence the size of any type of device. Additionally, even with the larger or additional battery, the battery (or batteries) may still have a shorter lifespan than the expected 5-year lifespan.

Another technique is to not connect the embedded controller to the coin battery. This reduces the amount of drain on the battery, thereby assisting with the coin battery maintaining its 5-year lifespan. However, by not having the embedded controller connected to the coin battery, intruder events may not be detected. Thus, when a device is in a mechanical-off state, the device will lack the ability to track when hardware components are being adjusted, swapped, removed, and/or the like. Additionally, and/or alternatively, removal of a power source prior to hardware adjustments provides an avenue for intruders to stealthily adjustment hardware components without being noticed. This leaves hardware components of devices highly susceptible to being compromised. Therefore, what is needed is a system and method that may detect and record an intruder event even when the device in a mechanical-off state, while reducing the drain on the coin battery caused by connection of the embedded controller to the coin battery.

Accordingly, the described system and method provides a technique for utilizing a microcontroller unit added to a device in order to detect intruder events of a device while the device is in a mechanical-off state with no external power. The microcontroller of a device that is in a mechanical-off state with no external power, also known as the G3 state of a device, may detect an intruder event. An intruder event is an instance when the housing or chassis of a device is breached. Such an intruder event may include a user (e.g., an employee, an unauthorized person, etc.) accessing the innerworkings and/or hardware components of a device. The microcontroller unit may log the intruder event. When logging the intruder event, the microcontroller unit of the device may log data associated with the intruder event and store this data for future reference. The data may include a timestamp associated with the intruder event. This timestamp is based upon a clock of the microcontroller unit, which may or may not match the clock of the device. Thus, the microcontroller unit has an ability to identify when the intruder event happens and save the data of the intruder event.

The microcontroller unit requires much less power than an embedded controller, which means that connection of the microcontroller unit to the coin battery as opposed to the embedded controller reduces the drain on the coin battery by the component used for intruder event detection. Upon powering-on the device or providing external power to the device, the data corresponding to the intruder event logged by the microcontroller unit may be provided from the microcontroller unit to an embedded controller of a device. The embedded controller of the device can then utilize the information logged by the microcontroller unit regarding the intruder event in a traditional manner. Since the clock of the microcontroller unit and the embedded controller may not be in sync, the system may calculate a real time of the intruder event to produce the most accurate real time of the intruder event.

The illustrated example embodiments will be best understood by reference to the figures. The following description is intended only by way of example, and simply illustrates certain example embodiments.

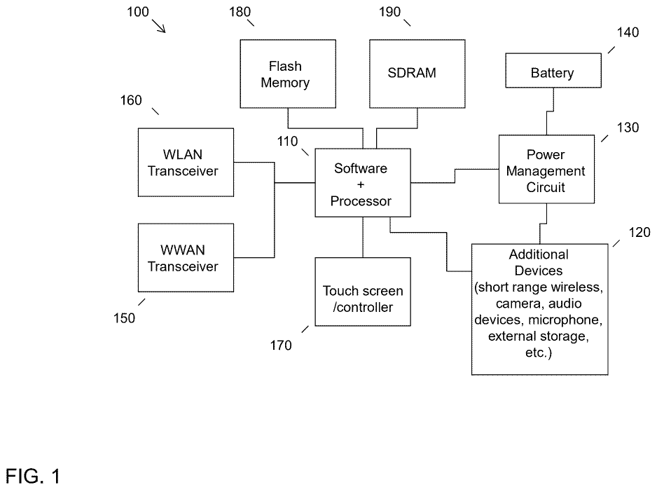

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

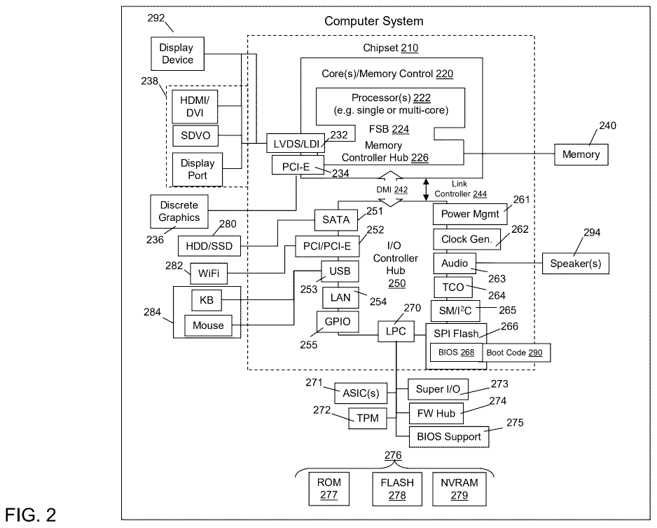

FIG. 2 depicts a block diagram of another example of information handling device circuits, circuitry, or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may include coin batteries, to which microcontroller units for intruder event detection may be added, and/or the like. For example, the circuitry outlined in FIG. 1 may be implemented in a tablet or smart phone embodiment, whereas the circuitry outlined in FIG. 2 may be implemented in a personal computer embodiment.

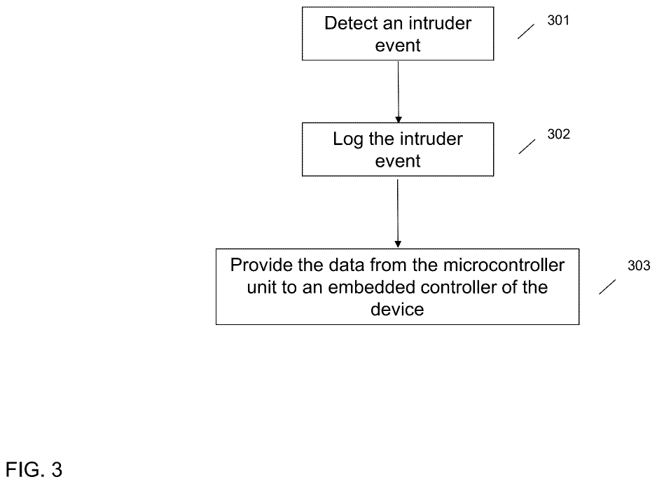

FIG. 3 illustrates an example method for utilizing a microcontroller unit added to a device in order to detect intruder events of a device while the device is in a mechanical-off state. The method may be implemented on a system which includes a processor, memory device, output devices (e.g., display device, printer, etc.), input devices (e.g., keyboard, touch screen, mouse, microphones, sensors, biometric scanners, etc.), image capture devices, and/or other components, for example, those discussed in connection with FIG. 1 and/or FIG. 2. While the system may include known hardware and software components and/or hardware and software components developed in the future, the system itself is specifically programmed to perform the functions as described herein to detect an intruder event at a device using a lower power device as compared with traditional techniques. Additionally, the intruder detection system includes modules and features that are unique to the described system.

The described intruder detection system may be activated when a device is put in a mechanical-off, no external power state, also referred to as a G3 state. In the G3 state, many components of the device no longer have power provided to them. However, some components are powered through a coin battery, or other internal power source. Some components are necessary to keep powered in order to retain certain functions of the device, for example, to power a real-time clock, to detect intruder events, and/or the like. In typical systems, an embedded controller may be powered by the internal power source in the G3 state. However, in the described intruder detection system, a microcontroller unit has been added to the device. The microcontroller unit is smaller and requires less power than the embedded controller. Thus, the microcontroller unit has less drain on an internal power source as compared to the embedded controller. This microcontroller unit is given the function of detecting intruder events. Additionally, to further reduce the drain of the microcontroller unit on the battery, the microcontroller unit may be kept in a sleep state unless, or until, an intruder event is detected. The microcontroller unit then logs the intruder event, and then returns to a sleep state. Thus, the microcontroller unit stays in a relatively low power state, further reducing the drain on the internal power source.

At 301, the intruder detection system may detect, using the microcontroller unit of the device, an intruder event at an information handling device while in a mechanical-off, no external power state. An intruder event corresponds to an event when the chassis or housing of the device has been breached. For example, an intruder event may correspond to when the internal hardware components of a device are attempted to be accessed by a user (e.g., an owner, an employee, an unauthorized person, etc.). However, an intruder event does not require that any hardware components are accessed, added, removed, or otherwise modified. Rather, an intruder event may simply be the detection of the breach of the device chassis or housing. For example, the intruder event may be detected in response to a chassis of a device being opened and/or removed, the disconnection of a hardware component from a device, the removal of connection components (e.g., screws, latches, snaps, etc.) in order to open a device to reveal the inner components and/or motherboard of the device, and/or the like.

The detection of an intruder event does not designate between whether the intruder event is from an authorized or unauthorized breach of the chassis or housing. Thus, an intruder event may be an authorized access to one or more internal hardware components of a device or an unauthorized access to one or more internal hardware components or otherwise breaching the chassis or housing of the device. In other words, an intruder event may be the detection of a foreign influence on a device. In a device, accessing the hardware components of a device may include removal and/or opening of external components of a device. For example, hardware components of a smartphone may be accessed upon the removal of a display screen, showing the inner workings of the smart phone. A breach of the chassis or housing may include the removal of an external portion of a device in order to access internal components, for example, monitors, peripheral devices (e.g., mouse, keyboard, etc.), speakers, displays, covers, and/or the like. Additionally, the removal of external components may also be tracked by the system. Hardware components that may be being accessed through the breach of the chassis or housing may include, but are not limited to, a motherboard, a battery, a graphics card, a hard drive, memory cards, and/or the like.

In response to detecting an intruder event at a microcontroller unit of a device at 301, the intruder detection system may log the intruder event, at 302. Logging the intruder event includes storing at least a timestamp associated with the intruder event. Other information regarding the intruder event may also be logged with the intruder event. The microcontroller unit performs the logging of the intruder event, including storing the information in a data storage location accessible to and by the microcontroller unit. Since the microcontroller unit is connected to an internal power source (e.g., coin battery) that remains active as a power source while the device is in the G3 state, the internal clock of the microcontroller unit may be used to timestamp when the intruder event occurs.

It should be noted that the internal clock of the microcontroller unit (MCU) may not be synced with a clock of the device. In other words, the internal clock of the microcontroller may not match the clock of the device or even a real time. Timestamping of when the intruder event is detected may later be utilized to calculate a real time of the intruder event. The internal clock of the MCU may act as a traditional clock that measures 12- and/or 24-hour increments. Additionally, and/or alternatively, the internal clock of the MCU may operate as a timer and/or stopwatch that begins tracking time upon the transitioning from a power-on state to the G3 state. For example, when a device is powered down and external power is removed, the internal clock of the MCU may begin tracking a time since the beginning of the G3 state. Upon removal of the device from the G3 state (e.g., powering on the device, providing external power to the device, etc.), the internal clock of the MCU may stop. This removal of the device from the G3 state is an event that is logged within the device log. Thus, the system could calculate a real time for the intruder event based upon determining how long into the G3 state the intruder event was detected and a time since the G3 event ended.

Additionally, when logging the intruder event, the system may record additional details regarding the intruder event. For example, the MCU may log what internal hardware component of the device was influenced, what part of the chassis or housing was breached, how long the intruder event lasted, and/or the like. In other words, the microcontroller unit may record what component an intruder event was directed towards. If the coin battery is the component affected by the intruder event, the MCU can still log the intruder event even though power is no longer being supplied to the MCU. For example, the removal of a coin battery may deactivate the MCU while there is no internal power source. However, the MCU may log when the power was removed from the MCU and may also log when the power was restored to the MCU. As an example, the MCU may include one or more capacitors or the like that provide for some amount of extended operation (e.g., for logging, etc.) when a coin battery is removed or disconnected. Additionally, in another example, if a graphics card is removed from a device, the microcontroller unit may record when the graphics card is removed, the amount of time for which the graphics card is removed, and the time of reinsertion of a graphics card back into the device (e.g., assuming it is reinserted). In such an example, the internal clock of the microcontroller remains active even with the removal of a hardware component because the microcontroller unit is being powered by the internal power source of the device.

The logging of the intruder event may occur in real-time. In other words, the recording of the intruder event may occur simultaneously with the detection of the intruder event. Then, after the logging of the intruder event, the microcontroller unit may store the data associated with the intruder event until activation and/or powering-on of the device or the provision of external power to the device. Since traditional storage locations are not active in a mechanical-off state, the microcontroller unit may store the intruder event data in a storage location associated with the microcontroller unit. The storage of the intruder event data may be until the data can be provided to another component of the device. In other words, the MCU may only store the intruder event data until the intruder event data can be provided to another component and, may thereafter delete or overwrite the intruder event data. Additionally, and/or alternatively, the MCU may store the intruder event data for a length of time determined by a user, for a default length of time, until the data storage location of the MCU is needed for subsequent logging, and/or the like.

Upon powering the device (e.g., powering-on the device, providing external power to the device, etc.), the data corresponding to the intruder device is provided from the MCU to an embedded controller of the device, at 303. Powering the device provides the device power other than the internal power source, for example, external power via a wired or wireless charging method, power via a battery pack of the device, and/or the like. When powering the device, an embedded controller of the device is also powered. Additionally, a chipset of the device may also be activated or powered. The chipset of a device may include a clock that remains in operation in the G3 state, but that is separate from the internal clock of the microcontroller unit.

The clock of the chipset may be a continuous clock that tracks a 12- and/or 24-time frame that does not stop with the powering-off and/or removal of external power of a device. Generally, but possibly, the internal clock of the microcontroller unit and the chipset are not synced. Rather, these clocks operate independently of one another, and may be utilized in combination to determine the real time of when the intruder event occurred. In other words, the timestamp of the intruder event as logged by the MCU and the time kept by the chipset or other clock of the device can be correlated to determine the real time of the intruder event. The system may compare the timestamp from the microcontroller unit and compare the timestamp to time data of the chipset of the device.

As mentioned previously, the internal clock of the microcontroller unit and the clock of the chipset are not synced. Therefore, the time data of each component is commonly not the same time. For example, a microcontroller unit may determine that an intruder event occurred 1-hour after the device entered a G3 state, and the chipset may determine that the device entered the G3 state at 2100 EST. In this example, the system may determine from the time data received from each hardware component that the intruder event occurred at 2200 EST or at 10 PM EST. Subsequent to the calculating of the real time of the intruder event, the system may provide this information to a user, input this data into a system for tracking when intruder events occur, update a hardware component log associated with the device that was subject to the intruder event, and/or the like. Therefore, the described system provides a technique for detecting intruder events that requires less power than traditional techniques for detecting intruder events, thereby reducing the drain on an internal power source of the device.

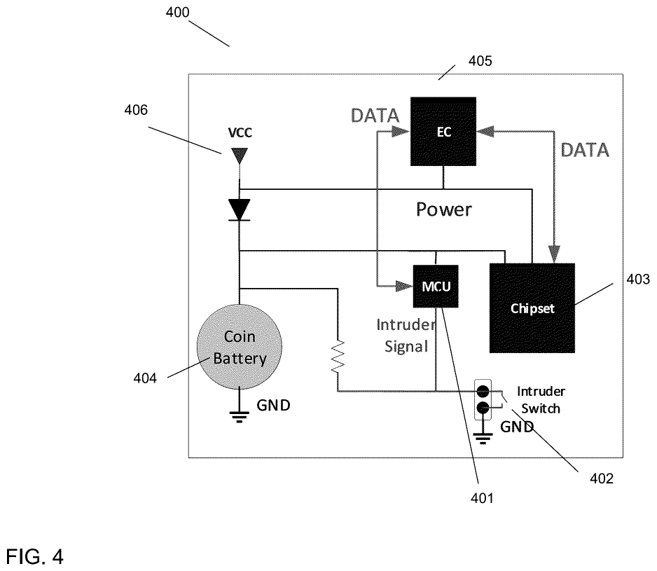

FIG. 4 illustrates an example of a simple information handing device circuitry containing a microcontroller unit. The circuitry illustrated shows a simple circuit of some of the inner components of device 400 that is in a G3 state. Within device 400, microcontroller unit 401 is in electrical connection with intruder switch 402 and coin battery 404. When device 400 is in the G3 state, the coin battery 404 provides power to the microcontroller unit 401. The microcontroller, even though it is powered, may remain in a sleep state until an intruder event is detected in order to conserve battery power. Upon detection of an intruder event, intruder switch 402 opens (or closes, depending on the normal state of the switch). The changing of the state of the intruder switch 402, causes a signal to be transmitted to microcontroller unit 401.

Upon detection of the signal, the microcontroller unit 401 logs a time associated with the detection of the signal. When intruder switch 402 changes state again (to the normal state of the switch), meaning the intruder event has ended, the internal clock of microcontroller unit 401 will log the time associated with the removal of the intruder event signal (or when the intruder event ended). Logging the intruder event may include timestamping when the intruder switch 402 changes state, logging which component present within the device 400 was influenced by the intruder event, how long the intruder event lasted, and/or the like. The log is stored in a data storage location accessible to or by the microcontroller unit 401. Once the intruder event has been logged, the MCU may return to a sleep state.

Chipset 403 includes a clock that remains active regardless of the state of the device 400. Chipset 403 may receive some power from low-power source 404 that allows the clock to remain accurate when a device 400 is in the G3 state. Then, when device 400 is powered (e.g., powered-on, external power is supplied through VCC 406, etc.), the chipset 403 will be powered by this power source. Additionally, upon powering of device 400, embedded controller (EC) 405 may also become active. Activation of embedded controller 405 may then result in the receipt of data of the intruder event from microcontroller 401 and time data from chipset 403. Embedded controller 405 may receive such data from microcontroller 401 and chipset 403 in order to calculate a real time of the intruder event. As mentioned previously, a calculation of a real time of the intruder event at embedded controller 405 is necessary because the data of intruder event recorded at microcontroller unit 401 is different than the time data present on chipset 403. Therefore, the embedded controller 405 may then output an accurate real time of the intruder event received at device 400 when in the G3 state. Such real time intruder event data may then be provided to a user identifying the intruder event, may be used to update a log of hardware components of device 400, and/or the like.

As will be appreciated by one skilled in the art, various aspects may be embodied as a system, method, or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices, and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
detecting, at a microcontroller unit of a device in a mechanical-off state, an intruder event;
logging, at the microcontroller unit of the device, the intruder event, wherein the logging comprises storing at least a timestamp associated with the intruder event; and
providing, upon powering the device, data corresponding to the intruder event from the microcontroller unit to an embedded controller of the device.

2. The method of claim 1, comprising calculating a real time of the intruder event based upon the timestamp.

3. The method of claim 2, wherein the calculating of the real time of the intruder event comprises utilizing the timestamp from the microcontroller unit and comparing the timestamp to time data of a chipset of the device;
wherein the chipset of the device comprises a clock and wherein the clock of the chipset and an internal clock of the microcontroller are not synced.

4. The method of claim 1, wherein the detecting of the intruder event comprises detecting at least one unauthorized adjustment of a hardware component of the device.

5. The method of claim 1, wherein the detecting of the intruder event comprises detecting an opening of a chassis of the device.

6. The method of claim 1, wherein the logging the intruder event occurs in real-time as the intruder event is detected.

7. The method of claim 1, wherein the microcontroller unit of the device is powered while the device is in the mechanical-off state.

8. The method of claim 1, wherein the microcontroller unit of the device is in a sleep state until the detecting of the intruder event.

9. The method of claim 8, wherein the microcontroller unit returns to the sleep state after performing the logging.

10. The method of claim 1, wherein the microcontroller unit of the device comprises an internal clock; and
wherein the logging the data of the intruder event comprises utilizing the internal clock to generate the timestamp of the intruder event.

11. A system, the system comprising:
a processor;
a memory device that stores instructions that, when executed by the processor causes the system to:
detect, at a device in a mechanical-off state, an intruder event;
log, at a microcontroller unit of the device, the intruder event, wherein to log comprises storage of at least a timestamp associated with the intruder event; and
provide, upon powering the device, data corresponding to the intruder event from the microcontroller unit to an embedded controller of the device.

12. The system of claim 11, wherein the instructions comprise instructions that, when executed by the processor, cause the system to perform a calculation of a real time of the intruder event based upon the timestamp.

13. The system of claim 12, wherein the calculation of the real time of the intruder event comprises utilization of the timestamp from the microcontroller unit and a comparison of the timestamp to time data of a chipset of the device;
wherein the chipset of the device comprises a clock and wherein the clock of the chipset and an internal clock of the microcontroller are not synced.

14. The system of claim 11, wherein to detect the intruder event comprises detection of at least one unauthorized adjustment of a hardware component of the device.

15. The system of claim 11, wherein to detect the intruder event comprises detection of an opening of a chassis of the device.

16. The system of claim 11, wherein the to log the intruder event occurs in real-time as the intruder event is detected.

17. The system of claim 11, wherein the microcontroller unit of the device is powered while the device is in the mechanical-off state.

18. The system of claim 11, wherein the microcontroller unit of the device is in a sleep state until the detection of the intruder event.

19. The system of claim 11, wherein the microcontroller unit of the device comprises an internal clock;
wherein to log the data of the intruder event comprises utilization of the internal clock to generate the timestamp of the intruder event.

20. A product, the product comprising:
a computer-readable storage device that stores executable code that, when executed by a processor, causes the product to:
detect, at a device in a mechanical-off state, an intruder event;
log, at a microcontroller unit of the device, the intruder event, wherein to log comprises storage of at least a timestamp associated with the intruder event; and
provide, upon powering the device, data corresponding to the intruder event from the microcontroller unit to an embedded controller of the device.
